(19) United States
(12) Patent Application Publication
(10) Pub. No.: US 2024/0351068 A1
(43) Pub. Date: Oct. 24, 2024

(54) RESONANT ACTUATOR VIBRATING WITH PERCEPTIBLE BEAT FREQUENCY FOR HAPTICS APPLICATIONS

(71) Applicant: Qorvo US, Inc., Greensboro, NC (US)

(72) Inventor: Tom A. Kwa, San Jose, CA (US)

(21) Appl. No.: 18/584,419

(22) Filed: Feb. 22, 2024

Related U.S. Application Data
(60) Provisional application No. 63/496,835, filed on Apr. 18, 2023.

(51) Int. Cl. B06B 1/02; G06F 3/01

(52) U.S. Cl. CPC B06B 1/0276; B06B 1/0215; G06F 3/016; B06B 2201/55

(57) ABSTRACT

The present disclosure relates to a haptics system with a resonant actuator that has a non-perceptible resonance frequency and is capable of vibrating with a perceptible beat frequency to create a tactile sensation without a large driving force. Within the disclosed haptics system, the resonant actuator is configured to receive a mixed driving signal that includes a first mixed driving signal portion and a second mixed driving signal portion. The first mixed driving signal portion has a first mixed frequency about the resonance frequency of the resonant actuator, and the second mixed driving signal portion has a second mixed frequency that is between 0 Hz and 500 Hz. The first mixed frequency is at least several times greater than the second mixed frequency.

### RELATED APPLICATIONS

This application claims the benefit of provisional patent application Ser. No. 63/496,835, filed Apr. 18, 2023, the disclosure of which is hereby incorporated herein by reference in its entirety.

### FIELD OF THE DISCLOSURE

The present disclosure relates to a haptics system with a resonant actuator that has a non-perceptible resonance frequency and is capable of vibrating with a perceptible beat frequency to create a tactile sensation without a large driving force, and a method of providing a tactile sensation using one resonant actuator with a non-perceptible resonance frequency.

### BACKGROUND

Haptics actuators, which vibrate to create a tactile sensation from touch surfaces, are widely used in mobile phones, tablets, smart watches, and gaming controllers to enhance the user experience. To be perceptible by a human fingertip, the vibration must occur at a frequency between 0 Hz and 500 Hz, with at least a certain displacement amplitude, which depends on a sensor and contact characteristics.

For a typical resonant actuator, to achieve resonance at a relatively low frequency range of human perceptibility, the actuator mass must be large, and the actuator stiffness must be low. This makes the actuator bulky and fragile, which is undesirable in portable and wearable devices. However, one resonant actuator with a small mass and high stiffness will be much more robust but will also have a resonance frequency that is outside the human perceptible range. On the other hand, if the resonant actuator vibrates below its resonance frequency, to achieve a perceptible displacement amplitude, a large driving force is required.

Accordingly, there remains a need for an improved haptics system design that provides human perceptible vibrations with a small mass and high stiffness resonant actuator without the need for a large driving force.

### SUMMARY

The present disclosure relates to a haptics system with a resonant actuator that has a non-perceptible resonance frequency and is capable of vibrating with a perceptible beat frequency to create a tactile sensation without a large driving force. Within the disclosed haptics system, the resonant actuator is configured to receive a mixed driving signal that includes a first mixed driving signal portion and a second mixed driving signal portion. The first mixed driving signal portion has a first mixed frequency about the resonance frequency of the resonant actuator, and the second mixed driving signal portion has a second mixed frequency that is between 0 Hz and 500 Hz. The first mixed frequency is at least several times greater than the second mixed frequency.

In one embodiment of the haptics system, the resonance frequency of the resonant actuator is greater than 1 kHz.

In one embodiment of the haptics system, the resonance frequency of the resonant actuator is tens of kHz.

In one embodiment of the haptics system, the first mixed frequency of the first mixed driving signal portion is between 90% and 110% of the resonance frequency of the resonant actuator.

In one embodiment of the haptics system, the first mixed driving signal portion and the second mixed driving signal portion have a same mixed amplitude.

In one embodiment of the haptics system, the mixed amplitude is between 10V and 200V.

According to one embodiment, the haptics system further includes a frequency mixer. Herein, the frequency mixer is configured to provide the mixed driving signal to the resonant actuator based on a first driving signal and a second driving signal received by the frequency mixer. A first frequency of the first driving signal and a second frequency of the second driving signal are selected, such that the first mixed frequency is about the resonance frequency of the resonant actuator and the second mixed frequency is between 0 Hz and 500 Hz.

In one embodiment of the haptics system, the first mixed frequency within the mixed driving signal is equal to a sum of the first frequency and the second frequency, while the second mixed frequency within the mixed driving signal is equal to a difference between the first frequency and the second frequency.

In one embodiment of the haptics system, the first mixed frequency of the first mixed driving signal portion is more than ten times greater than the second mixed frequency of the second mixed driving signal portion.

In one embodiment of the haptics system, the first mixed frequency of the first mixed driving signal portion is hundreds of times greater than the second mixed frequency of the second mixed driving signal portion.

According to one embodiment, the haptics system further includes a first oscillator and a second oscillator. The first oscillator is configured to provide the first driving signal with the first frequency to the frequency mixer, and the second oscillator is parallel to the first oscillator and configured to provide the second driving signal with the second frequency to the frequency mixer.

In one embodiment of the haptics system, the first oscillator and the second oscillator are resistor-capacitor (RC) oscillators, inductor-capacitor (LC) oscillators, crystal oscillators, or micro-electromechanical systems (MEMS) oscillators.

In one embodiment of the haptics system, the resonant actuator is a micro-electromechanical systems (MEMS) haptics actuator.

According to one embodiment, an exemplary method for providing a tactile sensation using a haptics system starts with providing a first driving signal with a first frequency and a second driving signal with a second frequency. Next, the first driving signal is mixed with the second driving signal to provide a mixed driving signal that includes a first mixed driving signal portion with a first mixed frequency and a second mixed driving signal portion with a second mixed frequency. Herein, the first frequency and the second frequency are selected, such that the first mixed frequency is about a resonance frequency of a resonant actuator in the haptics system, and the second mixed frequency is between 0 Hz and 500 Hz. The first mixed frequency is at least several times greater than the second mixed frequency. The resonant actuator is then driven with the mixed driving signal.

In one embodiment of the method, the first mixed frequency is equal to a sum of the first frequency and the second frequency, while the second mixed frequency is equal to a difference between the first frequency and the second frequency.

In one embodiment of the method, the resonance frequency of the resonant actuator is greater than 1 kHz.

In one embodiment of the method, the resonance frequency of the resonant actuator is tens of kHz.

In one embodiment of the method, the first mixed frequency of the first mixed driving signal portion is between 90% and 110% of the resonance frequency of the resonant actuator.

According to one embodiment, a communication device includes a control system and user interface circuitry. Herein, at least one of the control system and the user interface circuitry includes a resonant actuator, which is configured to receive a mixed driving signal that includes a first mixed driving signal portion and a second mixed driving signal portion. The first mixed driving signal portion has a first mixed frequency about a resonance frequency of the resonant actuator, and the second mixed driving signal portion has a second mixed frequency that is between 0 Hz and 500 Hz. The first mixed frequency is at least several times greater than the second mixed frequency.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates a block diagram of an exemplary haptics system with a resonant actuator according to some embodiments of the present disclosure.

FIGS. 2A-2B illustrate driving signals for the resonant actuator of the haptics system illustrated in FIG. 1.

FIG. 3 illustrates a visualized tactile sensation sensed from the overall vibration output provided by the resonant actuator of the haptics system illustrated in FIG. 1.

FIG. 4 provides a flow diagram that illustrates an exemplary process of providing a tactile sensation using the haptics system illustrated in FIG. 1.

FIG. 5 illustrates a block diagram of an exemplary communication device that includes at least one resonant actuator illustrated in FIG. 1.

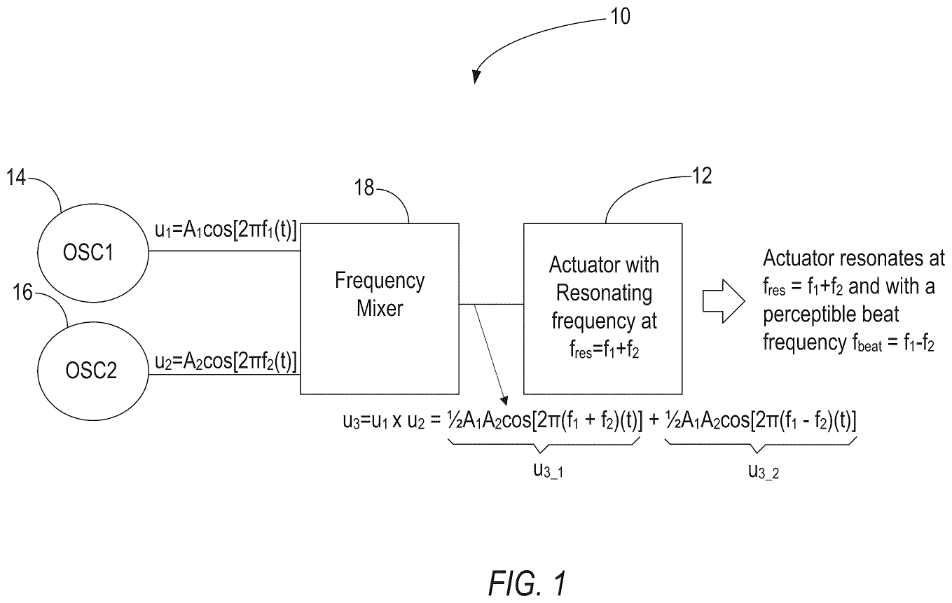

It will be understood that for clear illustrations, FIGS. 1-5 may not be drawn to scale.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

A typical actuator for haptics applications is a second-order mechanical system (mass-spring-damper), which vibrates to create a tactile sensation from touch surfaces. To be perceptible by a human fingertip, vibrations caused by the actuator must occur at a frequency between 0 Hz and 500 Hz, with at least a certain displacement amplitude, which depends on a sensor and contact characteristics (e.g., a contact area).

Compared to non-resonant actuators, resonant actuators will have more robust structures for equivalent sensations. When one resonant actuator is driven at or near its resonance frequency, the displacement amplitude of vibration is amplified by the quality factor of the mechanical system. When the resonant actuator is driven below its resonance frequency, the displacement amplitude will be directly proportional to the applied driving force and inversely proportional to the stiffness of the resonant actuator's suspension. For large displacement amplitude without utilizing a large driving force, it is therefore beneficial to drive one resonant actuator at its resonance frequency. However, to achieve resonance at a relatively low frequency range of human perceptibility, the resonant actuator requires a large mass and low stiffness, which makes the mechanical system bulky and fragile, and in consequence, not desirable for portable and wearable devices. The resonant actuator with little mass and high stiffness will be much more robust but will also have a resonance frequency that is outside the human perceptible range.

The present disclosure relates to a haptics system with a resonant actuator that has a high resonance frequency (i.e., higher than a perceptible frequency range of a human fingertip) and is still capable of providing a perceptible displacement without a large driving force.

FIG. 1 illustrates a block diagram of an exemplary haptics system 10 with a resonant actuator 12 according to some embodiments of the present disclosure. Besides the resonant actuator 12, the haptics system 10 further includes a first oscillator 14, a second oscillator 16, and a frequency mixer 18.

In detail, the first oscillator 14 and the second oscillator 16 are parallel to each other and both coupled to the frequency mixer 18. The first oscillator 14 and the second oscillator 16 may be resistor-capacitor (RC) oscillators, inductor-capacitor (LC) oscillators, crystal oscillators, micro-electromechanical systems (MEMS) oscillators, or the like. The first oscillator 14 is configured to provide a first driving signal u₁, while the second oscillator 16 is configured to provide a second driving signal u₂.

$${u}_{1} = {A}_{1} cos [ 2 π {f}_{1} ( t ) ] \qquad ( 1 )$$

$${u}_{2} = {A}_{2} cos [ 2 π {f}_{2} ( t ) ] \qquad ( 2 )$$

Herein, the first driving signal u₁ has a first amplitude A₁ and a first frequency f₁, while the second driving signal u₂ has a second amplitude A₂ and a second frequency f₂. The first frequency f₁ is different from the second frequency f₂. The first amplitude A₁ and the second amplitude A₂ may be the same or different.

The frequency mixer 18 is configured to receive the first driving signal u₁ and the second driving signal u₂, and is configured to provide a mixed driving signal u₃.

$$\begin{matrix}{u}_{3} = {u}_{1} \times {u}_{s} \\ = {\underbrace{1 / 2 {A}_{1} {A}_{2} cos [ 2 π ( {f}_{1} + {f}_{2} ) ( t ) ]}}_{{u}_{3 \_ 1}} + \\ {\underbrace{1 / 2 {A}_{1} {A}_{2} cos [ 2 π ( {f}_{1} - {f}_{2} ) ( t ) ]}}_{{u}_{3 \_ 2}}\end{matrix} \qquad ( 3 )$$

Herein, the mixed driving signal u₃ has two signal portions: a first mixed driving signal portion u_{3_1} and a second mixed driving signal portion u_{3_2}. The first mixed driving signal portion u_{3_1} has an amplitude ½A₁A₂ with a first mixed frequency equal to a sum of the first frequency f₁ and the second frequency f₂, (f₁+f₂). The second mixed driving signal portion u_{3_2} has an amplitude ½A₁A₂ with a second mixed frequency equal to a difference between the first frequency f₁ and the second frequency f₂, (f₁−f₂).

The resonant actuator 12 is coupled to the frequency mixer 18 and configured to receive the mixed driving signal u₃ from the frequency mixer 18 as its driving force. In one embodiment, the resonant actuator 12 is a micro-electromechanical systems (MEMS) haptics actuator. The MEMS technology provides a chip-scale solution for the resonant actuator 12. Fabricating the MEMS haptics actuator offers benefits such as on-chip Application-Specific Integrated Circuit (ASIC) integration.

It is important that the first frequency f₁ of the first driving signal u₁ and the second frequency f₂ of the second driving signal u₂ are carefully selected, such that the first mixed frequency (f₁+f₂) of the first mixed driving signal portion u_{3_1} is about a resonance frequency of the resonant actuator 12 (e.g., the first mixed frequency (f₁+f₂) is between 90% and 110% of the resonance frequency of the resonant actuator 12). To avoid bulkiness and fragility of the resonant actuator 12, the resonance frequency of the resonant actuator 12 is relatively high and cannot be perceptible to human beings (e.g., the resonance frequency is greater than 1 kHz, and in practicality the resonance frequency is tens of kHz). In addition, the first frequency f₁ of the first driving signal u₁ and the second frequency f₂ of the second driving signal u₂ are also selected, such that the second mixed frequency (f₁−f₂) of the second mixed driving signal portion u_{3_2} is within a perceptible frequency range of human beings (e.g., the first frequency f₁ of the first driving signal u₁ is close to the second frequency f₂ of the second driving signal u₂). The first mixed frequency (f₁+f₂) is at least a couple of times larger than the second mixed frequency (f₁−f₂). For robustness of the resonant actuator 12, the first mixed frequency (f₁+f₂) is more than ten times, or even hundreds of times, greater than the second mixed frequency (f₁−f₂).

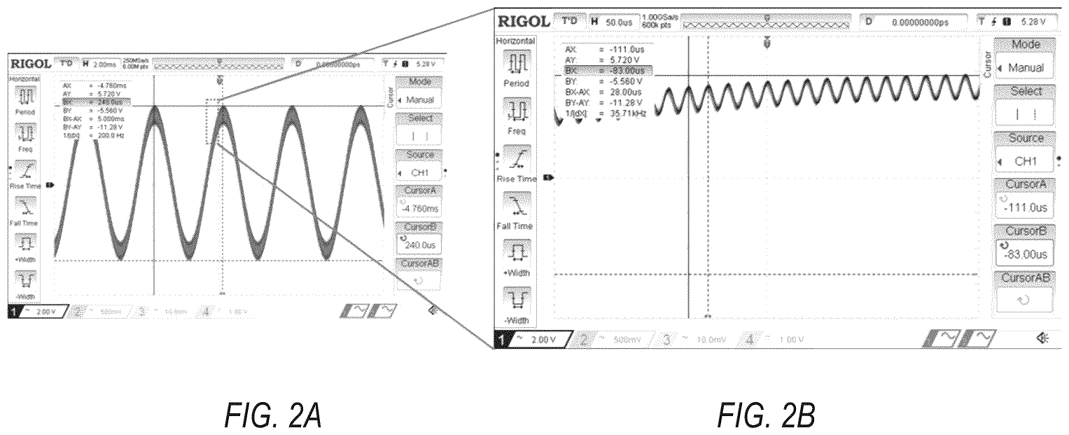

FIG. 2A illustrates a waveform plot of the mixed driving signal u₃ that includes the first mixed driving signal portion u_{3_1} with the first mixed frequency (f₁+f₂) and the second mixed driving signal portion u_{3_2} with the second mixed frequency (f₁−f₂). FIG. 2B illustrates a zoomed-in version of the mixed driving signal u₃ with details of the first mixed driving signal portion u_{3_1}. For the purpose of this illustration, f₁=18 kHz and f₂=17.8 kHz. In FIG. 2A, time cursors are showing f₁−f₂=200 Hz, while in FIG. 2B, the time cursors are showing f₁+f₂=35.8 kHz.

The resonant actuator 12 is driven at the first mixed frequency (f₁+f₂) and the second mixed frequency (f₁−f₂). As described above, since the first mixed frequency (f₁+f₂) is at or near the resonance frequency of the resonant actuator 12, the vibration provided by the resonant actuator 12 at the first mixed frequency (f₁+f₂) is amplified by the quality factor of the resonant actuator 12. In addition, the resonant actuator 12 also vibrates at the second mixed frequency (f₁−f₂). The overall vibration output of the resonant actuator 12 can be perceptible without a large driving force. It is because the resonant actuator 12 is driven about its resonance frequency (f₁+f₂) to gain the maximum displacement and is modulated with the perceptible frequency (f₁−f₂), so that the vibration of the resonant actuator 12 can be tactilely sensed. In other words, the displacement from the perceptible vibration at (f₁−f₂) is enhanced by the displacement from the resonant vibration at (f₁+f₂) so as to be perceptible. To provide an equivalent tactile sensation, a driving signal with a single perceptible frequency (e.g., f₁−f₂, much lower than the resonance frequency of the resonant actuator 12) applied to the resonant actuator 12 needs to have an amplitude that is much greater than the amplitude ½A₁A₂ of the mixed driving signal u₃. It is because the vibration displacement will not be amplified by the quality factor of the resonant actuator 12 when the resonant actuator 12 is driven at a frequency well below its resonance frequency. Herein, the amplitude ½A₁A₂ of the mixed driving signal might be between 10V and 200V.

Furthermore, the resonant actuator 12 within the haptics system 10 requires a lower driving force and power requirement for an equivalent sensation created by a non-resonant actuator.

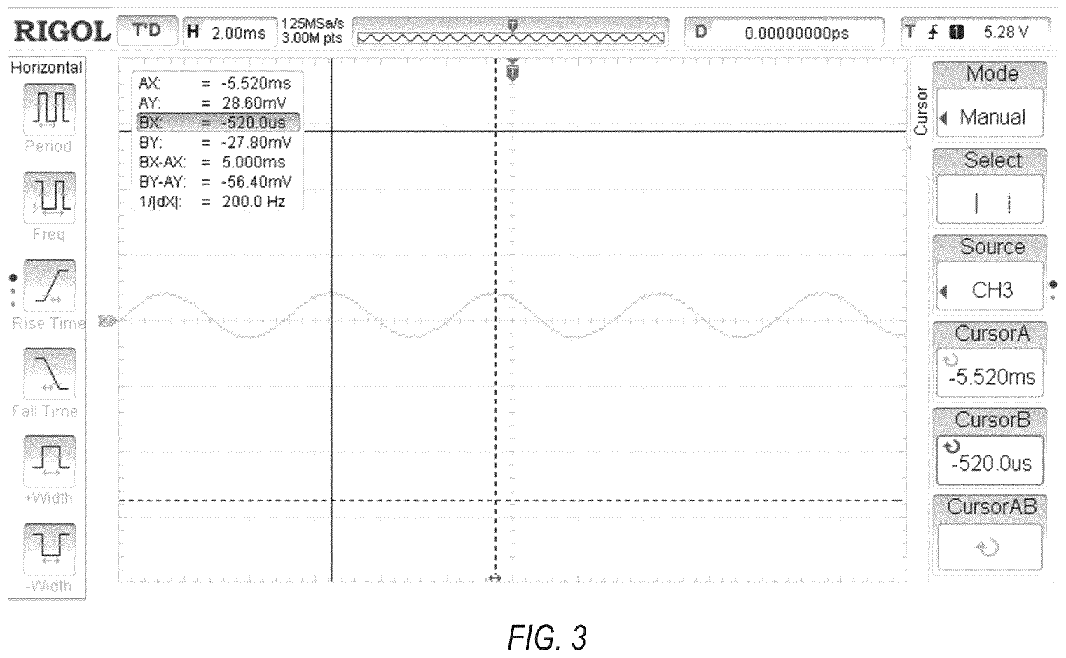

An accelerometer, which has roughly a same frequency and displacement response as a human fingertip, is mounted on the resonant actuator 12 (not shown) to simulate the sensation experienced by a human fingertip. FIG. 3 illustrates a visualized tactile sensation output of the accelerometer sensed from the overall vibration output provided by the resonant actuator 12. It is clear that the overall vibration output provided by the resonant actuator 12 is perceptible (non-perception would be represented by a flat line).

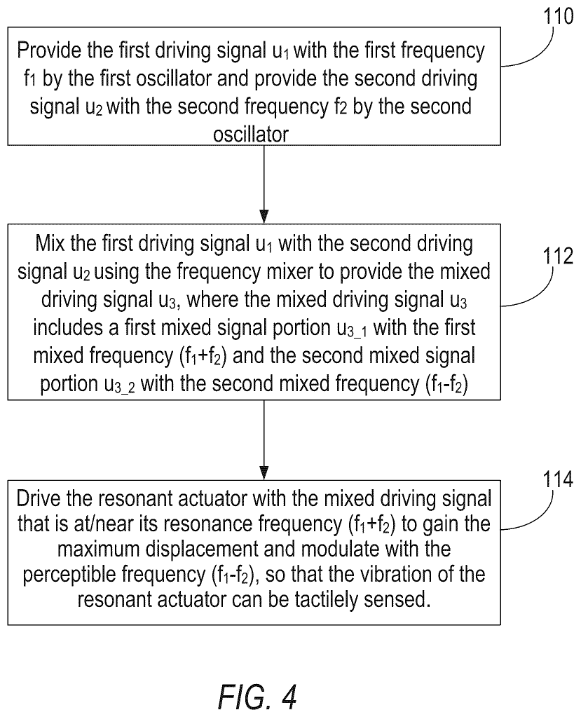

FIG. 4 provides a flow diagram that illustrates an exemplary method of providing a tactile sensation using the haptics system 10 illustrated in FIG. 1. The method begins by providing the first driving signal u₁ with the first frequency f₁ by the first oscillator 14 and providing the second driving signal u₂ with the second frequency f₂ by the second oscillator 16 (step 110). Herein, the first frequency f₁ and the second frequency f₂ are carefully selected, such that the sum of the first and second frequencies (f₁+f₂) is about the resonance frequency of the resonant actuator 12 (i.e., (f₁+f₂) is between 90% and 110% of the resonance frequency of the resonant actuator 12), and the difference between the first and second frequencies (f₁−f₂) is within a perceptible frequency range of human beings (e.g., the frequency f₁ of the first driving signal u₁ is close to the frequency f₂ of the second driving signal u₂). Typically, the sum of the first and second frequencies is at least dozens of times greater than the difference between the first and second frequencies.

Next, the first driving signal u₁ and the second driving signal u₂ are mixed by the frequency mixer 18 to provide the mixed driving signal u₃ (step 112). Herein, the mixed driving signal u₃ has two signal portions: the first mixed driving signal portion u_{3_1} with the first mixed frequency equal to the sum of the first and second frequencies (f₁+f₂), and the second mixed driving signal portion u_{3_2} with the second mixed frequency equal to the difference between the first and second frequencies (f₁−f₂).

The mixed driving signal u₃ is then used to drive the resonant actuator 12 (step 114). The resonant actuator 12 is driven at/near its resonance frequency (f₁+f₂) to gain the maximum displacement and is modulated with the perceptible frequency (f₁−f₂) so that it can be tactilely sensed.

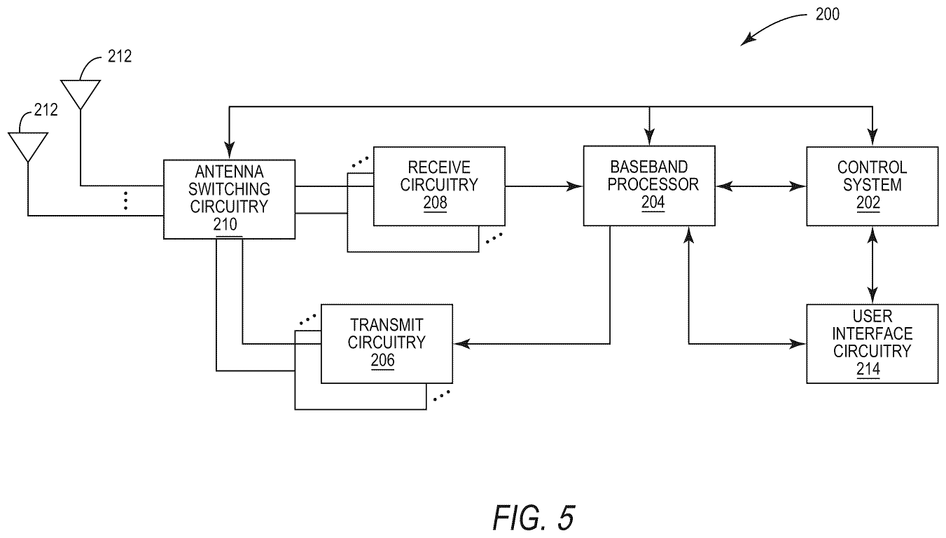

FIG. 5 illustrates a block diagram of an exemplary communication device 200 including at least one resonant actuator 12, which has a non-perceptible resonance frequency and is capable of vibrating with a perceptible beat frequency to create a tactile sensation without a large driving force. The communication device 200 can be any type of communication devices, such as mobile terminals, smart watches, tablets, computers, navigation devices, access points, base stations (e.g., eNB or gNB), and any other type of wireless communication devices that support wireless communications, such as cellular, wireless local area network (WLAN), BLUETOOTH, Ultra-wideband (UWB), and near field communications. The communication device 200 will generally include a control system 202, a baseband processor 204, transmit circuitry 206, receive circuitry 208, antenna switching circuitry 210, multiple antennas 212, and user interface circuitry 214. In a non-limiting example, the control system 202 can be a field-programmable gate array (FPGA) or an application-specific integrated circuit (ASIC), as an example. In this regard, the control system 202 can include at least a microprocessor(s), an embedded memory circuit(s), and a communication bus interface(s). In some applications, the control system 202 or the user interface circuitry 214 includes the resonant actuator 12 as illustrated in FIG. 1. In some applications, the control system 202 and/or the user interface circuitry 214 includes the entire haptics system 10 as illustrated in FIG. 1.

The receive circuitry 208 receives radio frequency signals via the antennas 212 and through the antenna switching circuitry 210 from one or more base stations. A low noise amplifier and a filter of the receive circuitry 208 cooperate to amplify and remove broadband interference from the received signal for processing. Down conversion and digitization circuitry (not shown) will then down convert the filtered, received signal to an intermediate or baseband frequency signal, which is then digitized into one or more digital streams using analog-to-digital converter(s) (ADC).

The baseband processor 204 processes the digitized received signal to extract the information or data bits conveyed in the received signal. This processing typically comprises demodulation, decoding, and error correction operations, as will be discussed in greater detail below. The baseband processor 204 is generally implemented in one or more digital signal processors (DSPs) and ASICs.

For transmission, the baseband processor 204 receives digitized data, which may represent voice, data, or control information, from the control system 202, which it encodes for transmission. The encoded data is output to the transmit circuitry 206, where a digital-to-analog converter(s) (DAC) converts the digitally encoded data into an analog signal and a modulator modulates the analog signal onto a carrier signal that is at a desired transmit frequency or frequencies. A power amplifier will amplify the modulated carrier signal to a level appropriate for transmission and deliver the modulated carrier signal to the antennas 212 through the antenna switching circuitry 210. The multiple antennas 212 and the replicated transmit and receive circuitries 206, 208 may provide spatial diversity. Modulation and processing details will be understood by those skilled in the art.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. A haptics system comprising:
a resonant actuator with a resonance frequency, wherein:
the resonant actuator is configured to receive a mixed driving signal that includes a first mixed driving signal portion and a second mixed driving signal portion;
the first mixed driving signal portion has a first mixed frequency about the resonance frequency of the resonant actuator, and the second mixed driving signal portion has a second mixed frequency that is between 0 Hz and 500 Hz; and
the first mixed frequency is at least several times greater than the second mixed frequency.

2. The haptics system of claim 1 wherein the resonance frequency of the resonant actuator is greater than 1 kHz.

3. The haptics system of claim 1 wherein the resonance frequency of the resonant actuator is tens of kHz.

4. The haptics system of claim 1 wherein the first mixed frequency of the first mixed driving signal portion is between 90% and 110% of the resonance frequency of the resonant actuator.

5. The haptics system of claim 1 wherein the first mixed driving signal portion and the second mixed driving signal portion have a same mixed amplitude.

6. The haptics system of claim 5 wherein the mixed amplitude is between 10V and 200V.

7. The haptics system of claim 1 further comprising a frequency mixer, wherein:
the frequency mixer is configured to provide the mixed driving signal to the resonant actuator based on a first driving signal and a second driving signal received by the frequency mixer; and
a first frequency of the first driving signal and a second frequency of the second driving signal are selected, such that the first mixed frequency is about the resonance frequency of the resonant actuator and the second mixed frequency is between 0 Hz and 500 Hz.

8. The haptics system of claim 7 wherein the first mixed frequency within the mixed driving signal is equal to a sum of the first frequency and the second frequency, while the second mixed frequency within the mixed driving signal is equal to a difference between the first frequency and the second frequency.

9. The haptics system of claim 8 wherein the resonance frequency of the resonant actuator is greater than 1 kHz.

10. The haptics system of claim 8 wherein the resonance frequency of the resonant actuator is tens of kHz.

11. The haptics system of claim 8 wherein the first mixed frequency of the first mixed driving signal portion is more than ten times greater than the second mixed frequency of the second mixed driving signal portion.

12. The haptics system of claim 8 wherein the first mixed frequency of the first mixed driving signal portion is hundreds of times greater than the second mixed frequency of the second mixed driving signal portion.

13. The haptics system of claim 7 further comprising:
a first oscillator configured to provide the first driving signal with the first frequency to the frequency mixer; and
a second oscillator parallel to the first oscillator and configured to provide the second driving signal with the second frequency to the frequency mixer.

14. The haptics system of claim 13 wherein the first oscillator and the second oscillator are resistor-capacitor (RC) oscillators, inductor-capacitor (LC) oscillators, crystal oscillators, or micro-electromechanical systems (MEMS) oscillators.

15. The haptics system of claim 1 wherein the resonant actuator is a MEMS haptics actuator.

16. A method for providing a tactile sensation using a haptics system comprising:
providing a first driving signal with a first frequency and a second driving signal with a second frequency;
mixing the first driving signal with the second driving signal to provide a mixed driving signal that includes a first mixed driving signal portion with a first mixed frequency and a second mixed driving signal portion with a second mixed frequency, wherein:
the first frequency and the second frequency are selected, such that the first mixed frequency is about a resonance frequency of a resonant actuator in the haptics system and the second mixed frequency is between 0 Hz and 500 Hz; and
the first mixed frequency is at least several times greater than the second mixed frequency; and
driving the resonant actuator with the mixed driving signal.

17. The method of claim 16 wherein the first mixed frequency is equal to a sum of the first frequency and the second frequency, while the second mixed frequency is equal to a difference between the first frequency and the second frequency.

18. The method of claim 17 wherein the first mixed frequency of the first mixed driving signal portion is between 90% and 110% of the resonance frequency of the resonant actuator.

19. The method of claim 17 wherein the resonance frequency of the resonant actuator is greater than 1 kHz.

20. The method of claim 17 wherein the resonance frequency of the resonant actuator is tens of kHz.

21. A communication device comprising:
a control system; and
user interface circuitry, wherein:
at least one of the control system and the user interface circuitry includes a resonant actuator;
the resonant actuator is configured to receive a mixed driving signal that includes a first mixed driving signal portion and a second mixed driving signal portion;
the first mixed driving signal portion has a first mixed frequency about a resonance frequency of the resonant actuator, and the second mixed driving signal portion has a second mixed frequency that is between 0 Hz and 500 Hz; and
the first mixed frequency is at least several times greater than the second mixed frequency.
